(19) United States
(12) Patent Application Publication
(10) Pub. No.: US 2026/0001308 A1
(43) Pub. Date: Jan. 1, 2026

(54) FABRIC AND ADHESIVE LAYUP WITH INSPECTION

(71) Applicant: The Boeing Company, Arlington, VA (US)

(72) Inventors: Austin B. Ball, Mercer Island, WA (US); Colin Aiden Paul Noronha, Burien, WA (US); Shuonan Dong, Seattle, WA (US)

(21) Appl. No.: 18/754,556

(22) Filed: Jun. 26, 2024

(51) Int. Cl. B32B 37/06; B32B 3/10; B32B 5/02; B32B 7/12; B32B 37/10; B32B 37/24; B32B 38/18; B32B 41/00

(52) U.S. Cl. CPC B32B 37/06; B32B 3/10; B32B 5/024; B32B 7/12; B32B 37/10; B32B 37/24; B32B 38/1841; B32B 41/00; B32B 2041/04; B32B 2305/188

(57) ABSTRACT

A multilayer composite layup system comprises a joining system and a layup system. The joining system is configured to join a fiber product layer and an adhesive to each other to form a joined layer. The layup system is configured to lay up the joined layer onto a surface of a composite workpiece.

### BACKGROUND INFORMATION

### 1. Field

The present disclosure relates generally to manufacturing composite parts and in particular, to laying up composite materials onto a composite workpiece.

### 2. Background

Aircraft are being designed and manufactured with greater and greater percentages of composite materials. Composite materials are used in aircraft to decrease the weight of the aircraft. This decreased weight can improve performance features such as payload capacity and fuel efficiency. Further, composite materials provide longer service life for various components in an aircraft.

Composite materials can be tough, light-weight materials created by combining two or more functional components. For example, a composite material can include reinforcing fibers bound in a polymer resin matrix, such as a carbon fiber reinforced polymer (CRFP). The fibers can be unidirectional, such as a tape or a tow, or can be multidirectional, such as a woven cloth or fabric. The fibers and resins can be arranged and cured to form a composite structure.

Using composite materials to create aerospace composite structures can allow for portions of an aircraft to be manufactured in larger pieces or sections. For example, a fuselage in an aircraft can be created in cylindrical sections to form the fuselage of the aircraft. Other examples include, without limitation, wing sections joined to form a wing or stabilizer sections joined to form a stabilizer.

A stringer is an example of a component that may be manufactured from composite materials. A stringer is an elongate member and is configured for attachment to another structure. This structure can be, for example, a panel such as a skin panel for an aircraft. The skin panel can be used in a wing, fuselage, or other component in the aircraft. The stringer also can help carry loads, transfer loads, or carry and transfer loads. For example, a stringer may transfer a load from a skin panel to another structure. This other structure may be, for example, a frame or a rib.

### SUMMARY

An embodiment of the present disclosure provides an end effector comprising a movement system, a layer heater, an actuatable carriage, and a layup roller. The movement system moves a fiber product layer and an adhesive within the end effector and aligns the fiber product layer and the adhesive relative to each other to form aligned layers. The layer heater heats the aligned layers to form heated aligned layers. The compactor compacts the heated aligned layers to form a joined layer. The actuatable carriage is moveable relative to a surface of a composite workpiece. The layup roller is connected to the actuatable carriage. The layup roller causes the adhesive in the joined layer to contact the surface of the composite workpiece such that the joined layer is laid up on the surface of the composite workpiece as the end effector moves along the surface of the composite workpiece. The actuatable carriage moves to change position relative to the surface such that the layup roller compacts the joined layer on the surface of the composite workpiece.

Another embodiment of the present disclosure provides a multilayer composite layup system comprising a joining system and a layup system. The joining system is configured to join a fiber product layer and an adhesive to each other to form a joined layer. The layup system is configured to lay up the joined layer onto a surface of a composite workpiece.

Still another embodiment of the present disclosure provides a method for laying up a joined layer. A radius filler in a channel in a surface of a composite workpiece is compacted. A fiber product layer and an adhesive are joined to form the joined layer. The joined layer is laid up on the radius filler in the channel in the surface of the composite workpiece.

Yet another embodiment of the present disclosure provides for laying up a joined layer. A fiber product layer and an adhesive are joined to each other to form the joined layer. The joined layer is laid up on a surface of a composite workpiece.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial illustration of a composite manufacturing environment in accordance with an illustrative embodiment;

FIG. 2 is an illustration of a block diagram of an illustration of a cross-sectional view of a stringer charge in accordance with an illustrative embodiment;

FIG. 3 is an illustration of a block diagram of a composite manufacturing environment in accordance with an illustrative embodiment;

FIG. 4 is an illustration of a joining system in accordance with an illustrative embodiment;

FIG. 5 is an illustration of a layup system in accordance with an illustrative embodiment;

FIG. 6 is an illustration of a compaction system in accordance with an illustrative embodiment;

FIG. 7 is an illustration of an inspection system in accordance with an illustrative embodiment;

FIG. 8 is an illustration of an end effector in accordance with an illustrative embodiment;

FIG. 9 is an illustration of a side view of an end effector in accordance with an illustrative embodiment;

FIG. 10 is an illustration of a bottom of an end effector in accordance with an illustrative embodiment;

FIG. 11 is an illustration of a flowchart of a process for laying up a joined layer on a composite workpiece in accordance with an illustrative embodiment;

FIG. 12 is an illustration of a flowchart of a process for preheating a composite workpiece in accordance with an illustrative embodiment;

FIG. 13 is an illustration of a flowchart of a process for inspecting a composite workpiece in accordance with an illustrative embodiment;

FIG. 14 is an illustration of a flowchart of a process for inspecting a composite workpiece in accordance with an illustrative embodiment;

FIG. 15 is an illustration of a flowchart of a process for laying up a joint layer on a composite workpiece in accordance with an illustrative embodiment;

FIG. 16 is an illustration of a flowchart of a process for preheating a composite workpiece in accordance with an illustrative embodiment;

FIG. 17 is an illustration of a flowchart of a process for inspecting a composite workpiece in accordance with an illustrative embodiment;

FIG. 18 is an illustration of a flowchart of a process for inspecting a composite workpiece in accordance with an illustrative embodiment;

FIG. 19 is an illustration of a flowchart of a process for inspecting components for joined layers in accordance with an illustrative embodiment;

FIG. 20 is an illustration of an aircraft manufacturing and service method in accordance with an illustrative embodiment; and

FIG. 21 is an illustration of a block diagram of an aircraft in which an illustrative embodiment may be implemented.

### DETAILED DESCRIPTION

The illustrative embodiments recognize and take into account one or more different considerations as described herein. In manufacturing a stringer, the steps to manufacture the stringer can be more time consuming than desired. The steps include placing layers of composite material such as tape onto a tool to form an elongated shape. This elongated shape is a stringer charge and has a groove or channel extending along a length of the stringer charge.

A radius filler is placed into the channel. The radius filler is a composite material and can also be referred to as a filler structure. Currently, numerous additional steps are performed to form the stringer charge. Currently, the steps are performed manually or using multiple automated devices.

For example, these additional steps include compacting the radius filler in the channel. This compaction can be performed to ensure that the radius filler is properly seated within the channel. The radius filler is inspected after compaction in one example.

Next, adhesive is laid up on the radius filler. The adhesive has a width and length such that the radius filler is covered by the adhesive. The adhesive is inspected for inconsistencies such as wrinkles, foreign object debris, and other types of inconsistencies.

A fiber product layer such as a plain weave fabric is laid up over the adhesive. This plain weave fabric can extend the life of the stringer charge and can have a width of the stringer charge. The plain weave fabric is inspected for inconsistencies prior to laying up other composite materials for other processing.

These different steps can take more time and effort than desired. Reducing the time needed for the steps can increase the speed at which stringers can be manufactured.

Thus, the illustrative examples provide a method, apparatus, and system for manufacturing a composite part such as a stringer in a manner that enables laying up the adhesive and plain weave fabric more quickly as compared to current techniques. For example, in these illustrative examples, the plain weave fabric and the adhesive can be combined into a single layer prior to being laid up on the radius filler. Thus, the plain weave fabric and adhesive can be laid up on the composite workpiece in a single pass.

In one illustrative example, automated layup of the plain weave fabric and adhesive is performed using a multilayer composite layup system that automatically lays up these two components as a single layer. For example, the multilayer layup system can comprise a joining system and a layup system. The joining system is configured to join a fiber product layer, such as the plain weave fabric, and an adhesive to each other to form a joined layer. The layup system is configured to lay up the joined layer onto a surface of a composite workpiece.

Thus, manufacturing of a stringer can be performed at a higher rate as compared to current techniques. Further, increased speed in manufacturing stringers can also occur by performing inspections in the same pass when laying up the joined layer. For example, in the same pass, an inspection can be performed for at least one of the radius filler prior to laying up the joined layer, inspection of the alignments of the plain weave fabric and adhesive that form the joined layer, or inspection of the joined layer after being laid up on the radius filler.

In the illustrative examples, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of items” is one or more operations.

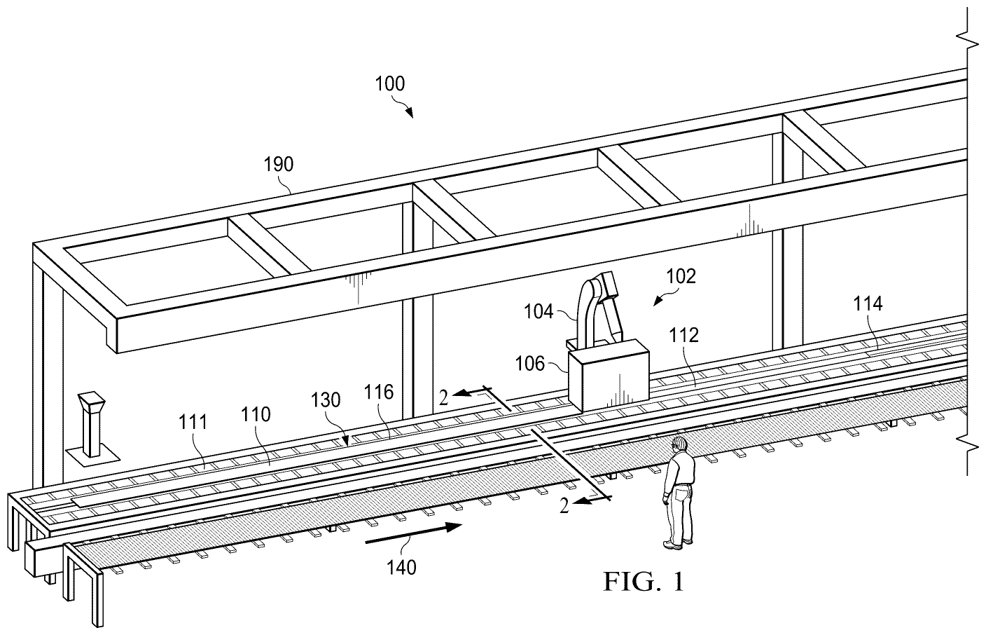

With reference now to the figures and, in particular, with reference to FIG. 1, a pictorial illustration of a composite manufacturing environment is depicted in accordance with an illustrative embodiment. In this illustrative example, composite manufacturing environment 100 is an environment in which a stringer is manufactured.

In this illustrative example, the speed at which the stringer can be manufactured is increased through the use of multilayer composite layup system 102. As depicted, multilayer composite layup system 102 comprises robotic arm 104 and end effector 106.

FIG. 1 is intended as an example, and not as an architectural limitation for the different illustrative embodiments.

In this illustrative example, stringer charge 110 is an example of a composite workpiece. Stringer charge 110 has been laid up on tool 111. As depicted, stringer charge 110 has channel 114 with radius filler 112 being located in channel 114.

As depicted, end effector 106 can be moved by robotic arm 104 in the direction of arrow 140. While moving in the direction of arrow 140, end effector 106 lays up joined layer 130 onto stringer charge 110.

In this illustrative example, joined layer 130 can be comprised of a plain weave fabric and adhesive. The plain weave fabric is an example of a fiber product layer. Plain weave fabric and the adhesive are joined to each other by the end effector 106 to form joined layer 130. In this example, heat can be used to join these two components to each other. Pressure can also be used in forming joined layer 130.

As depicted in this example, the plain weave fabric and the adhesive are laid up on surface 116 of stringer charge 110 in a single pass with end effector 106 being moved by robotic arm 104 in the direction of arrow 140. As a result, additional time needed to layup these two materials in two or more passes is avoided, increasing the speed at which stringer charge 110 can be completed for the stringer.

Additional operations can be performed by multilayer composite layup system 102 during movement of end effector 106 in the direction of arrow 140. For example, end effector 106 can compact radius filler 112 in channel 114 to ensure that radius filler 112 is seated properly within channel 114. When radius filler 112 is placed in channel 114, radius filler 112 may be slightly elevated or not fitting in channel 114. Radius filler 112 is considered to be seated when the radius filler is completely in channel 114. Some compaction may also occur.

As another example, end effector 106 can also perform inspection of radius filler 112 and channel 114 before or after or both before and after compaction is performed on radius filler 112 in channel 114.

Another operation that can be performed by end effector 106 includes heating stringer charge 110 prior to laying up joined layer 130 onto surface 116 of stringer charge 110. In this illustrative example, heating stringer charge 110 can enable joined layer 130 to better stick or adhere to stringer charge 110. This heating enhances the adhesive properties that allow for improved bonding between stringer charge 110 and joined layer 130.

Additionally, end effector 106 can perform an inspection of surface 116 of stringer charge 110 with joined layer 130 laid up on stringer charge 110. Additionally, end effector 106 can also perform an inspection of the alignment between the piece of the plain weave fabric that forms joined layer 130. This inspection can be performed prior to laying up joined layer 130. If a misalignment is present, then the layup of joined layer 130 can be halted to align these components.

In this illustrative example, these additional operations can be performed in the same pass as laying up joined layer 130. As a result, the speed at which the layup of stringer charge 110 to form a stringer can be performed more quickly by performing these different operations in a single pass of end effector 106.

The illustration of composite manufacturing environment 100 is an example of one implementation for an illustrative example and not meant to limit the manner in which other illustrative examples can be implemented. For example, this illustration is not meant to limit the manner in which other illustrative examples can be limited.

For example, one or more robotic arms with end effectors can be present in multilayer composite layup system 102 in addition to robotic arm 104 with end effector 106. These additional components can be used to layup joined layers for other stringers in addition to the stringer depicted in this example. Alternatively, these other additional components can layup a joined layer for other portions or sections of stringer charge 110.

In yet other examples, end effectors can be located in other locations in multilayer composite layup system 102. For example, an end effector can be located on gantry 190.

In still another illustrative example, one or more robotic arms in addition to robotic arm 104 can carry sensors such as vision systems with cameras that perform inspections while moving in the direction of arrow 140 such that the layup of joined layer 130 and inspections can be performed in a single pass. For example, one robotic arm can be located in front of robotic arm 104 to inspect stringer charge 110 prior to laying up joined layer 130. Another robotic arm can be located after robotic arm 104 and perform inspections of stringer charge 110 after the layup of joined layer 130. As a result, the layup of joined layer 130 in the inspections can be performed in a single pass.

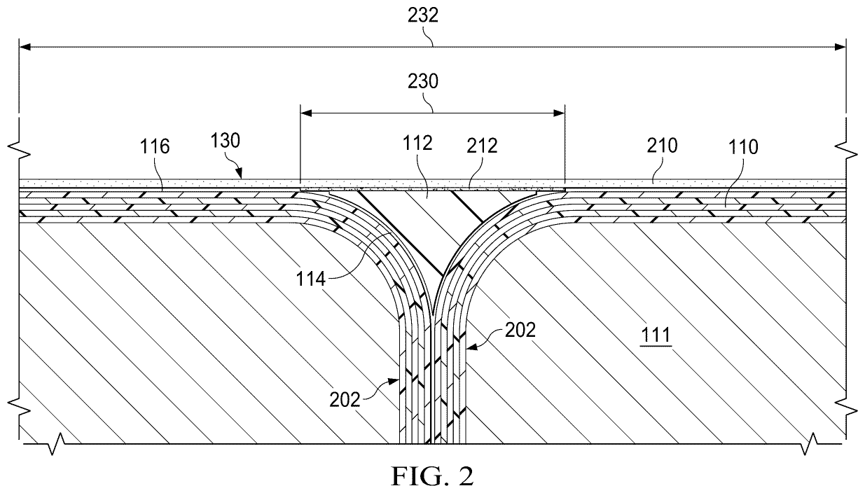

With reference now to FIG. 2, an illustration of a block diagram of an illustration of a cross-sectional view of a stringer charge is depicted in accordance with an illustrative embodiment. As depicted, a cross-sectional view of stringer charge 110 is shown in the direction of lines 2-2 in FIG. 1.

As seen in this cross-sectional view, stringer charge 110 is formed from tape layers 202 laid up on tool 111. Tape layers 202 on tool 111 have been shaped to include channel 114. Radius filler 112 is located in channel 114.

In this illustrative example, joined layer 130 has been laid up on to surface 116 of stringer charge 110. In this cross-sectional view, plain weave fabric 210 and adhesive 212 can be seen for joined layer 130. As depicted, adhesive 212 is located directly on radius filler 112. In this example, adhesive 212 directly contacts radius filler 112. As depicted, plain weave fabric 210 is the next layer after adhesive 212.

Plain weave fabric 210 and adhesive 212 have different widths in this cross-sectional view. In this illustrative example, adhesive 212 has width 230 which covers radius filler 112. Plain weave fabric 210 has width 232. In this example, this width for plain weave fabric 210 is the same as the width of tape layers 202 for stringer charge 110.

This illustration of stringer charge 110 is an example and not meant to limit the manner in which other illustrative examples can be implemented. For example, at least one of fabric or some other type of composite material can be used in place of or in addition to tape.

In another example, the width of plain weave fabric 210 may be less than the width of tape layers 202.

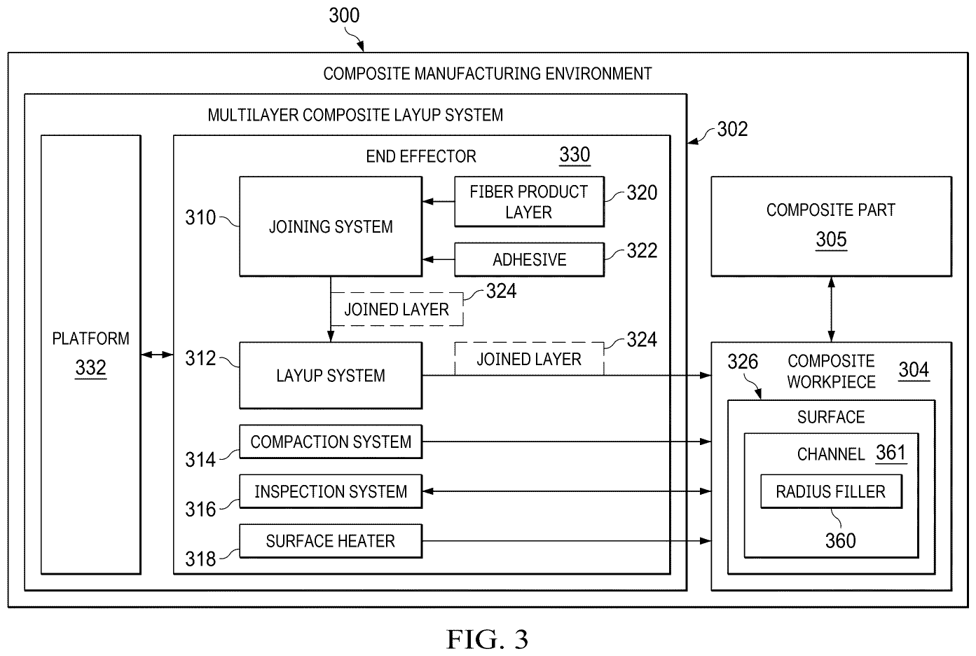

Turning to FIG. 3, an illustration of a block diagram of a composite manufacturing environment is depicted in accordance with an illustrative embodiment. In this illustrative example, composite manufacturing environment 100 in FIG. 1 is an example of an implementation for composite manufacturing environment 300 in FIG. 3.

Multilayer composite layup system 302 in composite manufacturing environment 300 can operate to perform operations on composite workpiece 304. Multilayer composite layup system 102 in FIG. 1 is an example of an implementation for multilayer composite layup system 302.

In this illustrative example, composite workpiece 304 can take a number of different forms. For example, composite workpiece 304 can be selected from a group comprising a shaped stringer charge with a radius filler, a composite charge with a radius filler, a layered laminate, a prepreg laminate, a sandwich panel, and other suitable types of workpieces.

Composite workpiece 304 can be used to form composite part 305. This composite part can be, for example, a stringer, a wing, a skin panel, a spar, a fuselage barrel, a cabin panel, and other suitable types of composite parts.

In this illustrative example, multilayer composite layup system 302 comprises a number of different components. As depicted, multilayer composite layup system 302 comprises joining system 310 and layup system 312.

Further in this illustrative example, joining system 310 joins fiber product layer 320 and adhesive 322 to each other to form joined layer 324. Fiber product layer 320 can be, for example, selected from a group comprising a fabric, a plain weave fabric, a carbon fiber weave, a tape, a tow, and other suitable types of fiber product layers. In this example, adhesive 322 can take a number of different forms. Adhesive 322 can be selected from at least one of a resin, a thermoplastic adhesive, a hot melt adhesive, film adhesive, a paste adhesive, or other types of adhesives is used on unconsolidated composite parts including prepreg composite parts.

Layup system 312 receives joined layer 324 from joining system 310. In this example, layup system 312 lays up joined layer 324 onto surface 326 of composite workpiece 304. In this example, the layup of these two components onto composite workpiece 304 is performed in a single operation using joined layer 324. This operation is a single pass of the system. This layup of these components in joined layer 324 is in contrast to currently used techniques.

Additionally, layup system 312 can also perform other operations. For example, layup system 312 can compact joined layer 324 as joined layer 324 is laid up onto surface 326 of composite workpiece 304.

In this illustrative example, layup system 312 also includes end effector 330. End effector 330 is a tool connected to platform 332. Joining system 310 and layup system 312 are located in end effector 330. The different components for the systems are connected. Platform 332 can be selected from a group comprising a robotic arm, a robot, a gantry, a rail system, or some other platform.

In this illustrative example, other components can also be located in end effector 330. For example, compaction system 314 can also be located in end effector 330 in multilayer composite layup system 302. Compaction system 314 compacts surface 326 of composite workpiece 304 prior to layup system 312 laying up joined layer 324 on to surface 326 of composite workpiece 304.

In this example, compaction can be performed to reduce voids and remove air trapped between the layers. Compaction can improve the density and uniformity of the composite material in composite workpiece 304. Compaction helps to ensure that the reinforcing fibers are properly impregnated with the resin matrix, enhancing the mechanical bond and overall structural integrity of composite part 305 formed from composite workpiece 304. As a result, composite part 305 can exhibit improved mechanical properties such as higher strength, stiffness, and improved durability as compared to not performing compaction.

Thus, the use of multilayer composite layup system 302 can enable forming composite workpiece 304 more quickly as compared to current techniques. In the illustrative example, multilayer composite layup system 302 can perform the different operations described in a single pass of end effector 330 on composite workpiece 304. In other words, these different operations can be performed as end effector 330 moves along surface 326 of composite workpiece 304.

In this illustrative example, inspection system 316 can also be located in end effector 330 in multilayer composite layup system 302. Inspection system 316 can perform a number of different types of inspections as part of laying up joined layer 324 on composite workpiece 304. For example, inspection system 316 is an inspection system configured to perform at least one of inspecting joined layer 324 laid up on composite workpiece 304 for at least one of an alignment of joined layer or foreign object debris on the surface of the composite workpiece; inspecting an alignment of fiber product layer 320 and adhesive 322 in joined layer 324 prior to joined layer 324 being laid up on composite workpiece 304; or inspecting a placement of radius filler 360 in channel 361 in surface 326 of composite workpiece 304 prior to joined layer 324 being laid up on radius filler 360.

End effector 330 in multilayer composite layup system 302 can also include surface heater 318. In this illustrative example, surface heater 318 is configured to heat surface 326 of composite workpiece 304 prior to layup system 312 laying up joined layer 324 on surface 326 of composite workpiece 304.

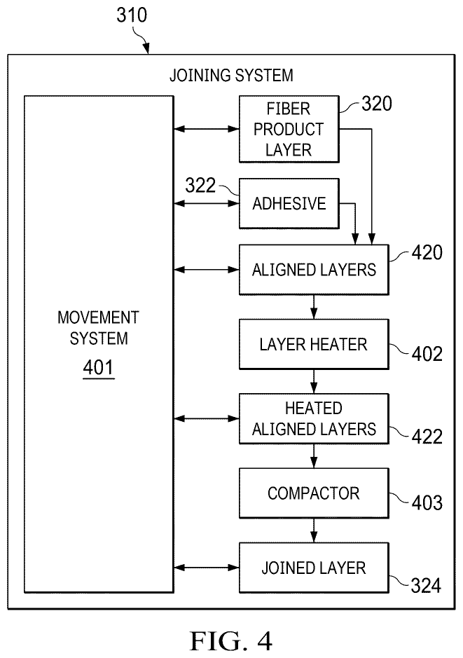

Turning next to FIG. 4, an illustration of a joining system is depicted in accordance with an illustrative embodiment. In the illustrative examples, the same reference numeral may be used in more than one figure. This reuse of a reference numeral in different figures represents the same element in the different figures.

Examples of components that can be used to implement joining system 310 are shown in this figure. In one illustrative example, joining system 310 comprises movement system 401, layer heater 402, and compactor 403.

In this depicted example, movement system 401 can be implemented using rollers. One or more of these rollers can be powered rollers. In this example, a power roller is a roller that is connected to a motor that turns the roller.

In this illustrative example, movement system 401 moves fiber product layer 320 and adhesive 322 relative to each other in multilayer composite layup system 302 to form aligned layers 420.

Movement system 401 also moves these aligned layers to layer heater 402. In this example, layer heater 402 heats aligned layers 420 moved to layer heater 402 by movement system 401 to form heated aligned layers 422. In the illustrative example, layer heater 402 comprises a number of heating units. A heating unit can be, for example, an infrared emitter, carbon fiber elements, a ceramic emitter, an induction heater, convection heater, or some other suitable type of heater.

In this illustrative example, heated aligned layers 422 are moved to compactor 403 by movement system 401. Compactor 403 compacts heated aligned layers to form joined layer 324. In this illustrative example, compactor 403 can be implemented using rollers. For example, a pair of rollers can be aligned such that the heated layers pass through the rollers. At least one of the rollers can be actuated to move towards the other roller to apply pressure to the heated layers forming joined layer 324.

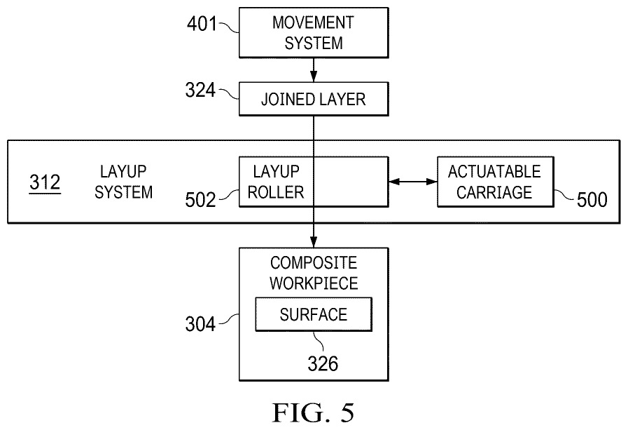

With reference to FIG. 5, an illustration of a layup system is depicted in accordance with an illustrative embodiment. Examples of components that can be used to implement joining system 310 are shown in this figure. In one illustrative example, joining system 310 comprises actuatable carriage 500 and layup roller 502.

In this illustrative example, actuatable carriage 500 is movable relative to surface 326 of composite workpiece 304. Actuatable carriage 500 can be moved towards or away from surface 326 of composite workpiece 304. In one example, actuatable carriage 500 can be movable in a direction that is substantially perpendicular to surface 326 of composite workpiece 304.

In this illustrative example, layup roller 502 is connected to actuatable carriage 500. When one component is “connected” to another component, the connection is a physical connection. For example, a first component, layup roller 502, can be considered to be physically connected to a second component, actuatable carriage 500, by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both. In some examples, the first component can be physically connected to the second component by being located within the second component.

Further in this example, movement system 401 moves joined layer 324 to layup roller 502. With this movement of joined layer 324 to layup roller 502, layup roller 502 causes the adhesive in joined layer 324 to contact surface 326 of composite workpiece 304 such that joined layer 324 is laid up on surface 326 of composite workpiece 304 as multilayer composite layup system 302 moves along surface 326 of composite workpiece 304. Additionally, actuatable carriage 500 moves to change position relative to surface 326 such that layup roller 502 compacts joined layer 324 on the surface 326 of composite workpiece 304.

Thus, multilayer composite layup system 302 enables performing forming multiple operations in a single pass along a composite workpiece. As discussed above, these different operations include laying up adhesive and a fiber product layer as a joined layer in a single pass rather than performing multiple operations in multiple passes to layup these layers separately. Additionally, other operations including at least one of compaction, heating, or inspection can be performed with respect to a composite workspace in a single pass.

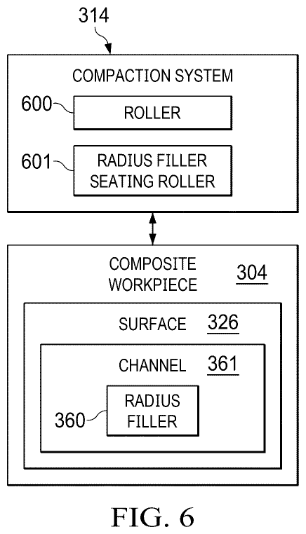

With reference next to FIG. 6, an illustration of a compaction system is depicted in accordance with an illustrative embodiment. In this illustrative example, compaction system 314 can comprise roller 600. In this example, roller 600 can be radius filler seating roller 601 when radius filler 360 is located in channel 361 of surface 326 of composite workpiece 304.

With this example, radius filler seating roller 601 seats radius filler 360 in channel 361 in surface 326 of composite workpiece 304 in response to radius filler seating roller 601 applying pressure while moving over radius filler 360 in channel 361.

In this example, the pressure used for compaction can occur through movement of end effector 330 towards surface 326. In other illustrative examples, the roller can be actuated to move relative to surface 326.

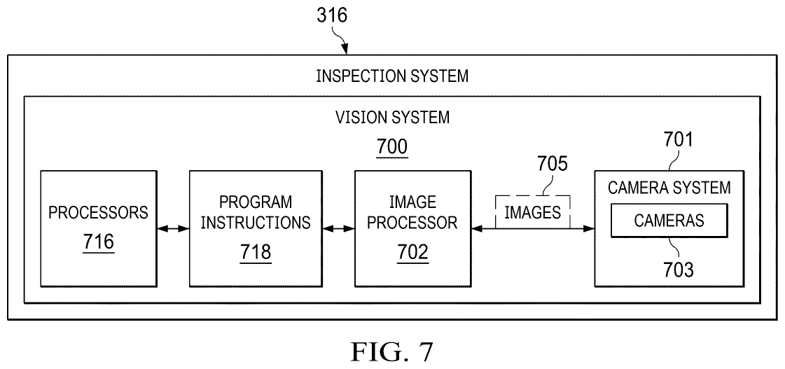

Turning now to FIG. 7, an illustration of an inspection system is depicted in accordance with an illustrative embodiment. In this depicted example, inspection system 316 can be vision system 700. In this example, vision system 700 comprises camera system 701 and image processor 702.

In one example, camera system 701 comprises a number of cameras 703 or other sensors. Camera system 701 can generate images 705 in the form of images for analysis.

In these examples, the analysis of images 705 is performed by image processor 702. Image processor 702 can be implemented in software, hardware, firmware, or a combination thereof. When software is used, the operations performed by image processor 702 can be implemented in program instructions configured to run on hardware, such as a processor unit. When firmware is used, the operations performed by image processor 702 can be implemented in program instructions and data can be stored in persistent memory to run on a processor unit. When hardware is employed, the hardware can include circuits that operate to perform the operations in program instructions 718 and are computer-readable program instructions.

As used herein, a processor unit in the number of processor units 716 is a hardware device and is comprised of hardware circuits such as those on an integrated circuit that respond to and process instructions and program code that operate a computer. The number of processor units 716 can be of the same type or different types of processor units. The number of processor units 716 can be selected from at least one of a single core processor, a dual-core processor, a multi-processor core, a general-purpose central processing unit (CPU), a graphics processing unit (GPU), a digital signal processor (DSP), or some other type of processor unit.

In this example, program instructions 718 for image processor 702 can implement a number of different types of processes. These processes can include at least one of a machine learning model, a statistical analysis process, a digital image processing technique, or other types of processes.

The illustration of composite manufacturing environment 300 in the different components illustrated in FIGS. 3-7 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, compaction system 314 can include one or more rollers in addition to roller 600 for compacting composite workpiece 304. In another illustrative example, multilayer composite layup system 302 can include one or more end effectors in addition to end effector 330. These additional end defectors can also lay up joined layers and perform other operations on composite workpiece 304 or other composite workpieces.

In yet another illustrative example, inspection system 316 can be implemented using a sensor system other than vision system 700. For example, one or more laser profilometers can be used to generate measurements for analysis.

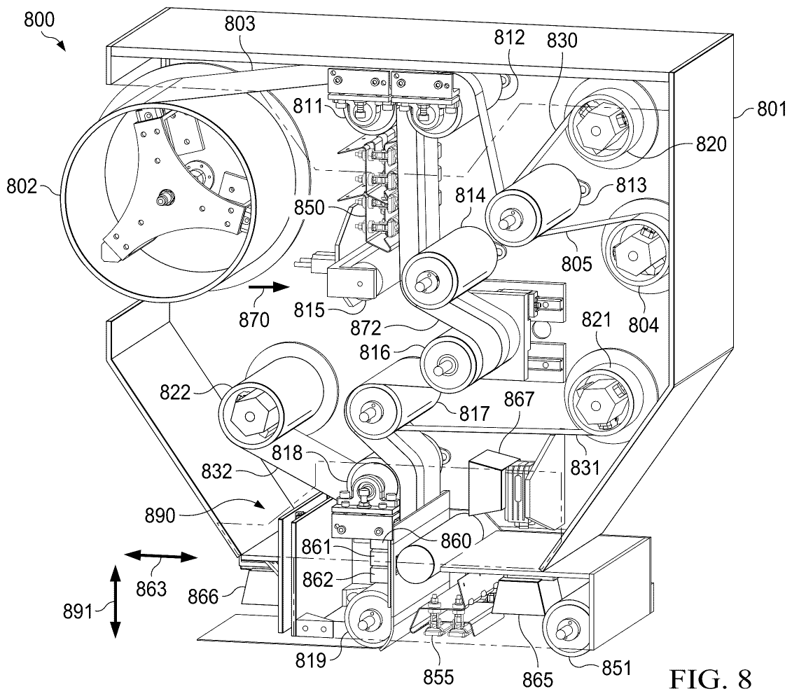

Next in FIG. 8, an illustration of an end effector is depicted in accordance with an illustrative embodiment. As depicted, end effector 800 is shown in a perspective view. End effector 800 is an example of an implementation for end effector 330 and the different components for end effector 330 are shown in block form in FIGS. 3-7.

As depicted, the different components are connected to housing 801. For example, plain weave supply roller 802 holds a supply of plain weave fabric 803. Plain weave fabric 803 is an example of a fiber product layer. Adhesive supply roller 804 holds a supply of adhesive 805. In this example, adhesive 805 is in the form of a film adhesive. These rollers are examples of components that can be implemented in movement system 401 for joining system 310 in FIG. 4 to move plain weave fabric 803 and adhesive 805.

As depicted, other rollers that can be implemented in movement system 401 include adjustable roller 811, adjustable roller 812, roller 813, roller 814, compaction roller 815, tension roller 816, roller 817, roller 818, and layup roller 819.

Other rollers that can be part of this movement system also include release poly film roller 820, adhesive backing paper roller 821, and plain weave backing paper roller 822. These rollers form a roller system that moves a fiber product such as plain weave fabric 803 and adhesive 805 within end effector 800.

In this example, these rollers along with plain weave supply roller 802 and adhesive supply roller 804 are powered rollers. A powered roller is a roller that includes or is connected to a motor or other actuator that rotates the roller.

In this illustrative example, release poly film roller 820 receives poly film 830 that is removed from adhesive 805 as adhesive 805 moves past roller 813. Adhesive backing paper roller 821 receives adhesive backing paper 831 that is removed from adhesive 805 as adhesive 805 moves past roller 817. Also in this example, plain weave backing paper roller 822 receives plain weave backing paper 832 as plain weave fabric 803 moves past roller 818.

In this example, adjustable roller 811 and adjustable roller 812 can be adjusted to align plain weave fabric 803 and adhesive 805 relative to each other to form the aligned layers. In this example, the alignment can be the alignment of the width of plain weave fabric 803 with the width of adhesive 805 such that the width of adhesive 805 is centered in the width of plain weave fabric 803.

These aligned layers are heated as these layers move past layer heater 850. These heated layers are compacted by compaction roller 815 and roller 814. In one illustrative example, these rollers can also be an implementation for compaction system 314 in FIG. 3.

In this example, compaction roller 815 can move relative to roller 814 to apply pressure to the heated aligned layers such that the heated aligned layers are compacted. For example, compaction roller 815 can move in the direction of arrow 870. This compaction of the heated aligned layers forms joined layer 872 that can be laid up onto a workpiece.

The aligned layers can physically contact each other in different locations within end effector 800. In one example, plain weave fabric 803 and adhesive 805 contact each other at adjustable roller 811 and adjustable roller 812. In another illustrative example, these aligned layers contact each other when compacted between compaction roller 815 and roller 814.

In this illustrative example, joined layer 872 is laid up onto a workpiece as joined layer 872 moves past layup roller 819. In this illustrative example, layup roller 819 is connected to actuatable carriage 890. This actuatable carriage can be moved relative to the surface of the composite workpiece. For example, actuatable carriage 890 can move in the direction of arrow 891. Roller 818 is also located in actuatable carriage 890.

In this depicted example, actuatable carriage 890 also includes clamp 860, feed roller 861, and cutter 862. These components can be used to control the layup of joined layer 872.

For example, clamp 860 can be moved in the direction of arrow 863 to clamp joined layer 872. By clamping joined layer 872, clamp 860 stops the feeding or movement of joined layer 872 onto the surface of the workpiece. Clamp 860 can hold joined layer 872 in place before starting another lay up of joined layer 872. For example, when the lay up of joined layer 872 has been completed for a composite workpiece, clamp 860 can hold joined layer 872 until another workpiece is ready for lay up or end effector 800 is moved to another portion of the composite workpiece to lay up another section of joined layer 872.

Feed roller 861 is a powered roller that can feed or advance joined layer 872 for lay up onto the surface of a workpiece. Further in this example, cutter 862 can cut joined layer 872 at the end of the layup of joined layer 872 onto the workpiece. This cutting by cutter 862 can occur at the same time or in response to the engagement of claim 860 with joined layer 872.

In this illustrative example, actuatable carriage 890 in end effector 800 also includes compaction roller 851. Compaction roller 851 can apply pressure onto the surface of the composite workpiece to perform compaction. This compaction can reduce wrinkles, crinkles, or other inconsistencies in the composite layers forming the composite workpiece.

Further, when a radius filler is present in a channel of a surface of the composite workpiece this compaction roller can apply pressure while moving over the radius filler in the channel. This pressure can be used to seat the radius filler within the channel.

In this example, the composite workpiece can be heated prior to laying up joined layer 872. For example, surface heater 855 can heat the composite workpiece. This heater is an example of an implementation of surface heater 318 in FIG. 3.

In this illustrative example, both layup roller 819 and compaction roller 851 are on the same vertical axis. However, these rollers can be actuated individually if different forces are required. In this example, actuatable carriage 890 keeps layup roller 819 the same distance from clamp 860, feed roller 861, and cutter 862 to ensure that cuts are accurate. This distance is also maintained to keep the tension present throughout the process of laying up joined layer 872.

In this illustrative example, inspections can be performed using end effector 800. These inspections can be performed using at least one of composite workpiece vision system 865, joined layup vision system 866, or alignment vision system 867. These vision systems can be an example of an implementation for inspection system 316 in FIG. 3 and FIG. 7. Each of these vision systems comprises a number of cameras. The number of cameras in a vision system can generate images that are analyzed for use in performing inspections. In some illustrative examples, a vision system can also include software and processing resources to perform an analysis of the images to perform the inspection.

In this illustrative example, composite workpiece vision system 865 is located in actuatable carriage 890 and can perform an inspection to determine whether inconsistencies are present in the workpiece. For example, this vision system can determine whether wrinkles, crinkles, or foreign object debris, or other inconsistencies are present on the surface of the composite workpiece prior to laying up joined layer 872.

As another example, when the composite workpiece includes a radius filler in a channel in the surface of the composite workpiece, the inspection can include determining whether the radius filler has been properly seated within the channel after compaction by compaction roller 851.

In this illustrative example, joined layup vision system 866 can perform an inspection to determine whether inconsistencies are present on the surface of the composite workpiece after laying up joined layer 872. In this illustrative example, the surface of the composite workpiece includes joined layer 872 after it has been laid up onto the composite workpiece. In this example, the inspection can be performed to determine whether any inconsistencies are present in response to laying up joined layer 872 onto the composite workpiece.

Further, alignment vision system 867 can be used to determine whether adhesive 805 and plain weave fabric 823 are properly aligned. For example, this vision system can determine whether the width of adhesive 805 is centered within the width of plain weave fabric 803.

In these illustrative examples, the results of the inspections can be used to perform various actions. These actions include halting layup of the joined layer onto the composite workpiece, adjusting the alignment of the plain weave fabric and the adhesive to each other, sync the inconsistency, or other suitable actions.

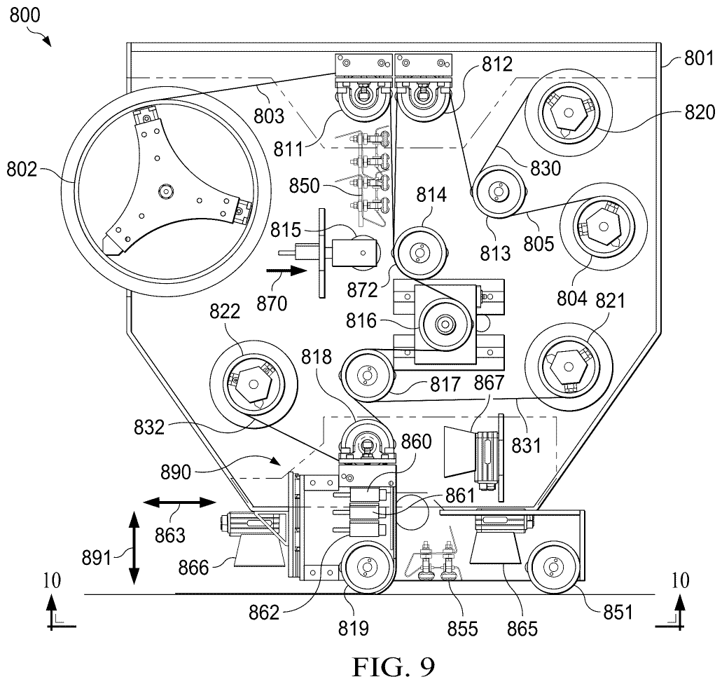

Turning now to FIG. 9, an illustration of a side view of an end effector is depicted in accordance with an illustrative embodiment. In this figure, a side view of end effector 800 is depicted.

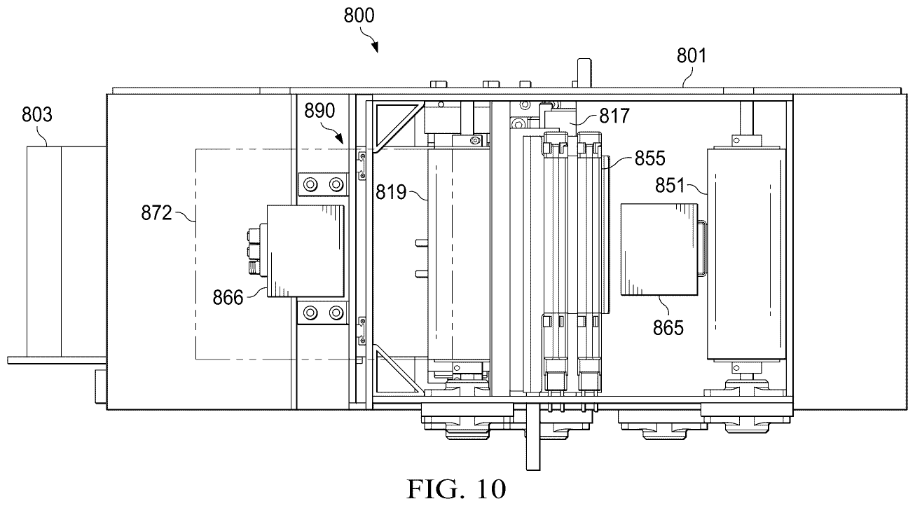

With reference next to FIG. 10, an illustration of a bottom of an end effector is depicted in accordance with an illustrative embodiment. In this illustrative example, a bottom view of end effector 330 is shown in the direction of lines 10-10 in FIG. 9.

The illustration of end effector 800 in FIGS. 8-10 are shown as an example of one implementation for end effector 330 in multilayer composite layup system 302 in FIGS. 3-7 and not meant to limit the manner in which other illustrative examples can be implemented. In one illustrative example, an actuatable carriage is not needed. Instead, end effector 800 can be moved by a robotic arm or another platform or component to which end effector 800 is connected to cause layup roller 819 to apply pressure to compact joined layer 872 onto the surface of a workpiece.

In another illustrative example, adhesive 805 can have other widths other than the one depicted. For example, adhesive 805 can have the same width as plain weave fabric 803. In yet another illustrative example, surface heater 855 can be located before compaction roller 851 to heat the composite workpiece prior to compaction.

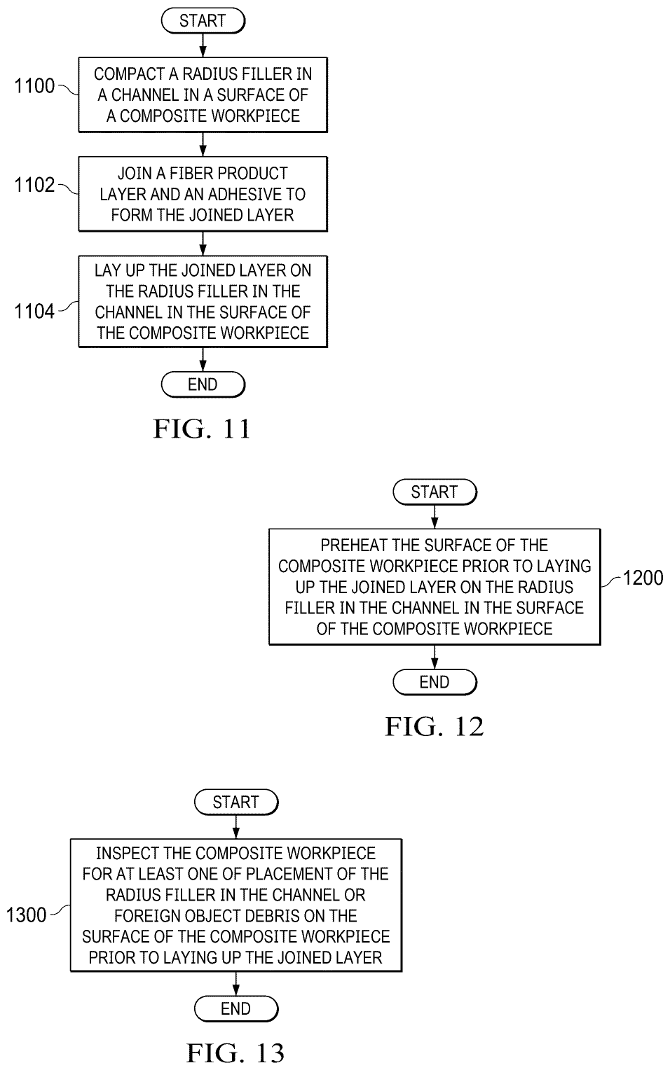

Turning next to FIG. 11, an illustration of a flowchart of a process for laying up a joined layer on a composite workpiece is depicted in accordance with an illustrative embodiment. The process in FIG. 11 can be implemented in hardware, software, or both. When implemented in software, the process can take the form of program instructions that are run by one of more processor units located in one or more hardware devices in one or more computer systems. For example, the process can be implemented in multilayer composite layup system 102 in FIG. 1 and multilayer composite layup system 302 in FIG. 3.

The process begins by compacting a radius filler in a channel in a surface of a composite workpiece (operation 1100). The process joins a fiber product layer and an adhesive to form the joined layer (operation 1102).

The process lays up the joined layer on the radius filler in the channel in the surface of the composite workpiece (operation 1104). The process terminates thereafter.

In FIG. 12, an illustration of a flowchart of a process for preheating a composite workpiece is depicted in accordance with an illustrative embodiment. The process in this figure is an example of an additional operation that can be performed with the operations in FIG. 11.

The process preheats the surface of the composite workpiece prior to laying up the joined layer on the radius filler in the channel in the surface of the composite workpiece (operation 1200). The process terminates thereafter. This preheating of the surface can also heat other layers of composite material under the surface of the composite workpiece.

Turning to FIG. 13, an illustration of a flowchart of a process for inspecting a composite workpiece is depicted in accordance with an illustrative embodiment. The process in this figure is an example of an additional operation that can be performed with the operations in FIG. 11.

The process inspects the composite workpiece for at least one of placement of the radius filler in the channel or foreign object debris on the surface of the composite workpiece prior to laying up the joined layer (operation 1300). The process terminates thereafter.

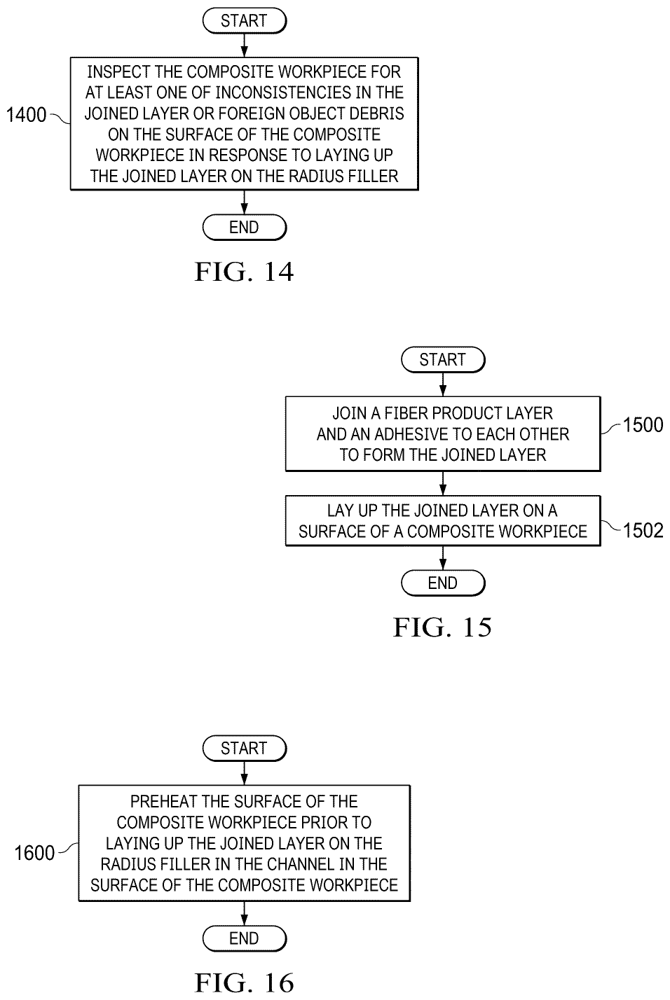

Next in FIG. 14, an illustration of a flowchart of a process for inspecting a composite workpiece is depicted in accordance with an illustrative embodiment. The process in this figure is an example of an additional operation that can be performed with the operations in FIG. 11.

The process inspects the composite workpiece for at least one of inconsistencies in the joined layer or foreign object debris on the surface of the composite workpiece in response to laying up the joined layer on the radius filler (operation 1400). The process terminates thereafter. This inspection can be performed to make sure inconsistencies are not present after laying up the joined layer. For example, the inspection can determine whether inconsistencies such as wrinkles, crinkles, foreign object debris, or other inconsistencies are present.

Turning next to FIG. 15, an illustration of a flowchart of a process for laying up a joint layer on a composite workpiece is depicted in accordance with an illustrative embodiment. The process in FIG. 15 can be implemented in hardware, software, or both. When implemented in software, the process can take the form of program instructions that are run by one of more processor units located in one or more hardware devices in one or more computer systems. For example, the process can be implemented in multilayer composite layup system 102 in FIG. 1 and multilayer composite layup system 302 in FIG. 3.

The process begins by joining a fiber product layer and an adhesive to each other to form the joined layer (operation 1500). The process lays up the joined layer on a surface of a composite workpiece (operation 1502). The process terminates thereafter.

In FIG. 16, an illustration of a flowchart of a process for preheating a composite workpiece is depicted in accordance with an illustrative embodiment. The process in this figure is an example of an additional operation that can be performed with the operations in FIG. 15.

The process preheats the surface of the composite workpiece prior to laying up the joined layer on the radius filler in the channel in the surface of the composite workpiece (operation 1600). The process terminates thereafter.

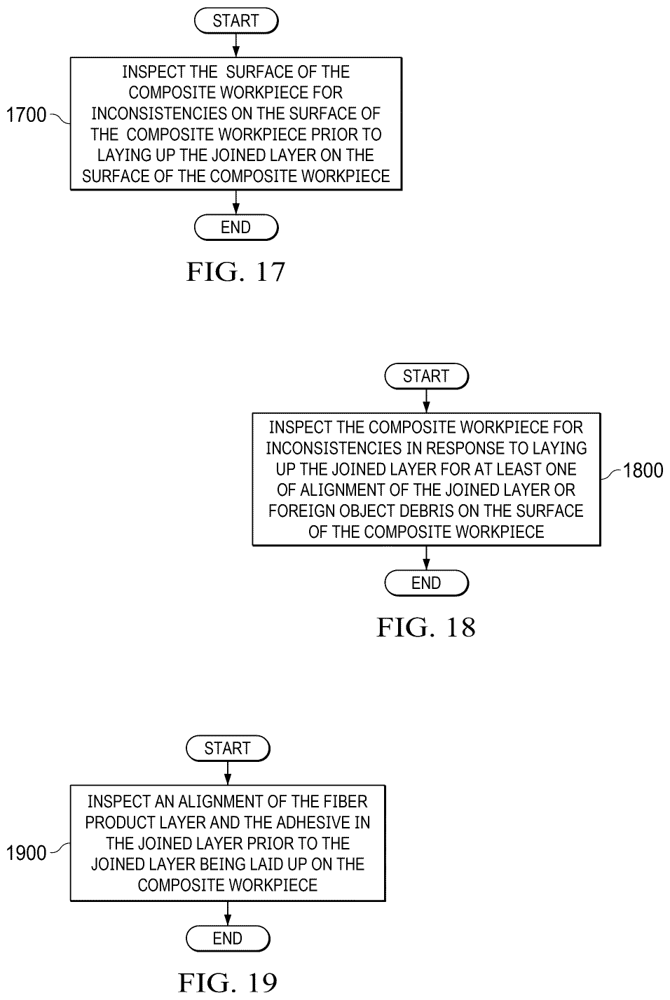

In FIG. 17, an illustration of a flowchart of a process for inspecting a composite workpiece is depicted in accordance with an illustrative embodiment. The process in this figure is an example of an additional operation that can be performed with the performed operations in FIG. 15.

The process inspects the surface of the composite workpiece for inconsistencies on the surface of the composite workpiece prior to laying up the joined layer on the surface of the composite workpiece (operation 1700). The process terminates thereafter. In operation 1700 the inconsistencies can include at least one of a wrinkle, a crinkle, foreign object debris, or other inconsistencies.

Next in FIG. 18, an illustration of a flowchart of a process for inspecting a composite workpiece is depicted in accordance with an illustrative embodiment. The process in this figure is an example of an additional operation that can perform the operations in FIG. 11.

The process inspects the composite workpiece for inconsistencies in response to laying up the joined layer for at least one of alignment of the joined layer or foreign object debris on the surface of the composite workpiece (operation 1800). The process terminates thereafter. In operation 1800, the inconsistencies can include at least one of a wrinkle, a crinkle, a misalignment of the joined layer on the composite workpiece, foreign object debris, or other inconsistencies.

Turning to FIG. 19, an illustration of a flowchart of a process for inspecting components for joined layers is depicted in accordance with an illustrative embodiment. The process in this figure is an example of an additional operation that performs the operations in FIG. 11.

The process inspects an alignment of the fiber product layer and the adhesive in the joined layer prior to the joined layer being laid up on the composite workpiece (operation 1900). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

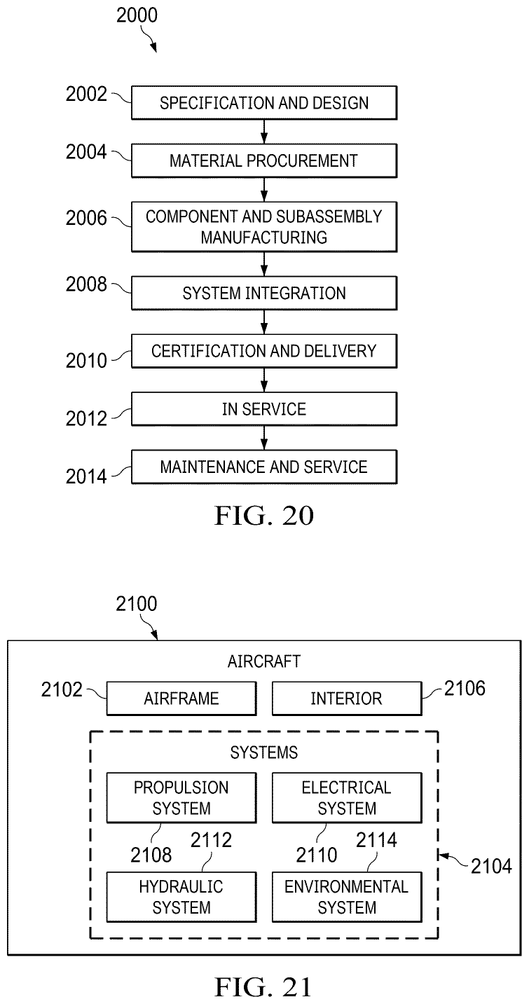

The illustrative embodiments of the disclosure may be described in the context of aircraft manufacturing and service method 2000 as shown in FIG. 20 and aircraft 2100 as shown in FIG. 21. Turning first to FIG. 20, an illustration of an aircraft manufacturing and service method is depicted in accordance with an illustrative embodiment. During pre-production, aircraft manufacturing and service method 2000 may include specification and design 2002 of aircraft 2100 in FIG. 21 and material procurement 2004.

During production, component and subassembly manufacturing 2006 and system integration 2008 of aircraft 2100 in FIG. 21 takes place. Thereafter, aircraft 2100 in FIG. 21 can go through certification and delivery 2010 in order to be placed in service 2012. While in service 2012 by a customer, aircraft 2100 in FIG. 21 is scheduled for routine maintenance and service 2014, which may include modification, reconfiguration, refurbishment, and other maintenance or service.

Each of the processes of aircraft manufacturing and service method 2000 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 21, an illustration of an aircraft is depicted in which an illustrative embodiment may be implemented. In this example, aircraft 2100 is produced by aircraft manufacturing and service method 2000 in FIG. 20 and may include airframe 2102 with plurality of systems 2104 and interior 2106. Examples of systems 2104 include one or more of propulsion system 2108, electrical system 2110, hydraulic system 2112, and environmental system 2114. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 2000 in FIG. 20.

In one illustrative example, components or subassemblies produced in component and subassembly manufacturing 2006 in FIG. 20 can be fabricated or manufactured in a manner similar to components or subassemblies produced while aircraft 2100 is in service 2012 in FIG. 20. As yet another example, one or more apparatus embodiments, method embodiments, or a combination thereof can be utilized during production stages, such as component and subassembly manufacturing 2006 and system integration 2008 in FIG. 20. One or more apparatus embodiments, method embodiments, or a combination thereof may be utilized while aircraft 2100 is in service 2012, during maintenance and service 2014 in FIG. 20, or both. The use of a number of the different illustrative embodiments may substantially expedite the assembly of aircraft 2100, reduce the cost of aircraft 2100, or both expedite the assembly of aircraft 2100 and reduce the cost of aircraft 2100.

For example, multilayer composite layup system 102 in FIG. 1 and multilayer composite layup system 302 in FIG. 3 can be used during component and subassembly manufacturing 2006 to manufacture composite parts more quickly as compared to currently used techniques. In this illustrative example, numerous operations that currently require multiple pieces of equipment or human assembly and inspection can be performed in a single pass using an illustrative example. Thus, manufacture of composite parts such as stringers that include radius fillers can be performed more quickly. Additionally, by implementing combining these operations in a single tool such as an end effector, the cost for manufacturing composite parts can also be reduced.

In one illustrative example, a multilayer composite layup system comprises a joining system and a layup system. The joining system is configured to join a fiber product layer and an adhesive to each other to form a joined layer. The layup system is configured to lay up the joined layer onto a surface of a composite workpiece.

With this multilayer composite layup system, the layup of these two components can be formed in a single operation. This type of processing is in contrast to current techniques which require human operators for multiple pieces of equipment to layup layers on a composite workpiece.

Further, in other illustrative examples other operations such as inspection, compaction of the composite workpiece prior to and after the layup of the joined layer can also be performed in a single pass of an end effector in the multilayer composite layup system.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An end effector comprising:
a movement system that moves a fiber product layer and an adhesive within the end effector and aligns the fiber product layer and the adhesive relative to each other to form aligned layers;
a layer heater that heats the aligned layers to form heated aligned layers;
a compactor that compacts the heated aligned layers to form a joined layer;
an actuatable carriage that is moveable relative to a surface of a composite workpiece; and
a layup roller connected to the actuatable carriage, wherein the layup roller causes the adhesive in the joined layer to contact the surface of the composite workpiece such that the joined layer is laid up on the surface of the composite workpiece as the end effector moves along the surface of the composite workpiece and wherein the actuatable carriage moves to change position relative to the surface such that the layup roller compacts the joined layer on the surface of the composite workpiece.

2. The end effector of claim 1 further comprising:
a compaction system configured to compact the surface of the composite workpiece prior to the end effector laying up the joined layer on the surface of the composite workpiece.

3. The end effector of claim 1, wherein a radius filler is located in a channel in the surface of the composite workpiece and further comprising:
a radius filler seating roller that seats the radius filler in the channel in the surface of the composite workpiece in response to the radius filler seating roller applying pressure while moving over the radius filler in the channel.

4. The end effector of claim 1 further comprising:
a surface heater that heats the surface of the composite workpiece prior to the joined layer being laid up on the composite workpiece.

5. The end effector of claim 1, wherein the end effector is connected to a platform selected from a group comprising a robotic arm, a robot, a gantry, and a rail system.

6. A multilayer composite layup system comprising:
a joining system configured to join a fiber product layer and an adhesive to each other to form a joined layer; and
a layup system configured to lay up the joined layer onto a surface of a composite workpiece.

7. The multilayer composite layup system of claim 6 further comprising:
a compaction system configured to compact the surface of the composite workpiece prior to the layup system laying up the joined layer on the surface of the composite workpiece.

8. The multilayer composite layup system of claim 6 further comprising:
an inspection system configured to perform at least one of:
inspect the joined layer laid up on the composite workpiece for at least one of an alignment of joined layer or foreign object debris on the surface of the composite workpiece;
inspect an alignment of the fiber product layer and the adhesive in the joined layer prior to the joined layer being laid up on the composite workpiece; or
inspect a placement of a radius filler in a channel in the surface of the composite workpiece prior to the joined layer being laid up on the radius filler.

9. The multilayer composite layup system of claim 6, wherein the joining system comprises:
a movement system that moves the fiber product layer and the adhesive relative to each other in the multilayer composite layup system to form aligned layers;
a layer heater that heats the aligned layers moved past the layer heater by the movement system to form heated aligned layers; and
a compactor that compacts the heated aligned layers to form the joined layer.

10. The multilayer composite layup system of claim 6, wherein the layup system is configured to compact the joined layer as the joined layer is laid up onto the surface of the composite workpiece.

11. The multilayer composite layup system of claim 6, wherein the layup system comprises:
an actuatable carriage moveable relative to the surface of the composite workpiece; and
a layup roller connected to the actuatable carriage, wherein layup roller causes the adhesive in the joined layer to contact the surface of the composite workpiece such that the joined layer is laid up on the surface of the composite workpiece as the multilayer composite layup system moves along the surface of the composite workpiece and wherein the actuatable carriage moves to change position relative to the surface such that the layup roller compacts the joined layer on the surface of the composite workpiece.

12. The multilayer composite layup system of claim 6 further comprising:
a surface heater configured to heat the surface of the composite workpiece prior to the layup system laying up the joined layer on the surface of the composite workpiece.

13. The multilayer composite layup system of claim 6, wherein a radius filler is located in a channel in the surface of the composite workpiece and further comprising:
a radius filler seating roller that seats the radius filler in the channel in the surface of the composite workpiece in response to the radius filler seating roller applying pressure while moving over the radius filler in the channel.

14. The multilayer composite layup system of claim 6, wherein the composite workpiece is selected from a group comprising a shaped stringer charge with a radius filler, a composite charge with a radius filler, a layered laminate, a prepreg laminate, and a sandwich panel.

15. The multilayer composite layup system of claim 6, wherein the fiber product layer is selected from a group comprising a fabric, a plain weave fabric, a carbon fiber weave, a tape, and a tow.

16. The multilayer composite layup system of claim 6, wherein the joining system and the layup system are located in an end effector.

17. The multilayer composite layup system of claim 16, wherein the end effector is connected to a platform selected from a group comprising a robotic arm, a robot, a gantry, and a rail system.

18. A method for laying up a joined layer, the method comprising:
compacting a radius filler in a channel in a surface of a composite workpiece;
joining a fiber product layer and an adhesive to form the joined layer; and
laying up the joined layer on the radius filler in the channel in the surface of the composite workpiece.

19. The method of claim 18 further comprising:
preheating the surface of the composite workpiece prior to laying up the joined layer on the radius filler in the channel in the surface of the composite workpiece.

20. The method of claim 18 further comprising:
inspecting the composite workpiece for at least one of placement of the radius filler in the channel or foreign object debris on the surface of the composite workpiece prior to laying up the joined layer.

21. The method of claim 18 further comprising:
inspecting the composite workpiece for at least one of inconsistencies in the joined layer or foreign object debris on the surface of the composite workpiece in response to laying up the joined layer on the radius filler.

22. A method for laying up a joined layer, the method comprising:
joining a fiber product layer and an adhesive to each other to form the joined layer; and
laying up the joined layer on a surface of a composite workpiece.

23. The method of claim 22 further comprising:
preheating the surface of the composite workpiece prior to laying up the joined layer on the surface of the composite workpiece.

24. The method of claim 22 further comprising:
inspecting the surface of the composite workpiece for inconsistencies.

25. The method of claim 22 further comprising:
inspecting the composite workpiece for inconsistencies in response to laying up the joined layer.

26. The method of claim 22 further comprising:
inspecting an alignment of the fiber product layer and the adhesive in the joined layer prior to the joined layer being laid up on the composite workpiece.
